(19) United States
(12) Patent Application Publication
(10) Pub. No.: US 2009/0132845 A1
(43) Pub. Date: May 21, 2009

(54) Power supply monitoring system and power supply apparatus through using software instruction

(75) Inventors: Tsung-Hsien Hsieh, Hsin-Tien (TW); Chia-Feng Yeh, Hsin-Tien (TW)

Correspondence Address: RABIN & Berdo, PC, 1101 14TH STREET, NW, SUITE 500, WASHINGTON, DC, 20005, US

(73) Assignee: GIGA-BYTE TECHNOLOGY CO., LTD., Hsin-Tien (TW)

(21) Appl. No.: 11/984,374

(22) Filed: Nov. 16, 2007

(51) Int. Cl. G06F 11/30

(52) U.S. Cl. 713/340

(57) ABSTRACT

A power supply monitoring system with power supply apparatus is operated by a software instruction. The power supply monitoring system includes a computer motherboard, a power supply, and a microprocessor. The microprocessor built in the power supply and coupled to an electro-thermal adjusting unit of the power supply; a transmission line, for connecting the microprocessor to a transmission interface of the computer motherboard; and a power supply status monitor program, for displaying operating status information of the power supply and providing a software instruction to control the electro-thermal adjusting unit of the power supply.

### BACKGROUND OF THE INVENTION

1. Field of the Invention

The present invention relates to a power supply monitoring system and a power supply, and more particularly to a power supply monitoring system and power supply apparatus through using a software instruction.

2. Related Art

As the information industry changes rapidly with each passing day and people have more and more different requirements on a personal computer and expect the personal computer to have versatile functions, a designer should try to design a personal computer (a system host) towards the trend of becoming an open system. The so-called open system means that the system host under design should not only meet the requirements of general standard configurations, but also ensure to provide sufficient additional resources for users to make subsequent expanding and upgrading, for example, the upgrading of a PCI interface, a disk array interface, a USB interface, or DIMM, or even the upgrading of CPU.

However, a user may use these additional resources to expand and upgrade a computer system, but he/she may also leave these resources unused. Therefore, how much of the resources will be used is unknown, i.e., the system load for the host is a variable difficultly to be grasped, which will be changed with the user's expanding requirements.

Therefore, it is very difficult for a power supply designer of an open system to reach a balance point between the consideration of cost and provision of a stable and sufficient power supply, because the system never knows how many interface cards or peripherals the user will use, or when the system host will reaches the maximum consumption.

Thus, the optimal management of the power supply becomes quite important. The information about an internal voltage and an internal current of a power supply for a conventional computer is always obtained and displayed through using a set of external fittings or displayed through using a display device installed to the power supply itself (point-type or digital display mode). However, such designs not only require a power supply, but almost of them also need a special display mode to display the information of the detected status for the power supply, so the device is complicated.

Therefore, it has become a concerned issue how to provide a power supply monitoring system and a power supply that are simple and capable of being widely used.

### SUMMARY OF THE INVENTION

In view of the aforementioned problems, the present invention is mainly directed to a power supply monitoring system through using a software instruction and a power supply. The internal information of a PC power supply is transmitted to a computer motherboard through a transmission line, and an operating status and relevant information in the power supply can be acquired in an operating system of a common computer through a software tool program for monitoring the power supply information. Meanwhile, the software may also control and adjust the rotating speed and the voltage of a fan within the power supply and the rotating speed of a fan in an external system through a microprocessor, so as to achieve a simple, rapid, and convenient control mode, which thus not only significantly enhances the convenience in monitoring the power supply, but also makes the hardware be installed more simply.

The power supply for being monitored through a software instruction provided by the present invention includes a microprocessor, coupled to an electro-thermal adjusting unit; and a power supply status monitor program, for displaying operating status information of the power supply and providing the software instruction to control the electro-thermal adjusting unit of the power supply.

Both the above descriptions of the present invention and the following detailed descriptions are intended to demonstrate and illustrate the principles of the invention, and to provide further explanations of the invention as claimed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a power supply monitoring system through using a software instruction according to the present invention;

FIG. 2 is a flow chart of displaying the operating status information of the power supply through a software instruction according to the present invention;

FIG. 3 is a flow chart of controlling the operating status information of the power supply through a software instruction according to the present invention;

FIG. 4A is a schematic view of a circuit for detecting a current through a microprocessor according to the present invention;

FIG. 4B is a schematic view of a circuit for detecting a voltage through a microprocessor according to the present invention; and

FIG. 5 is a schematic view of controlling the rotating speed of a fan for the power supply through a software instruction according to the present invention.

### DETAILED DESCRIPTION OF THE INVENTION

The features and practice of the preferred embodiments of the present invention will be illustrated below in detail with reference to the drawings.

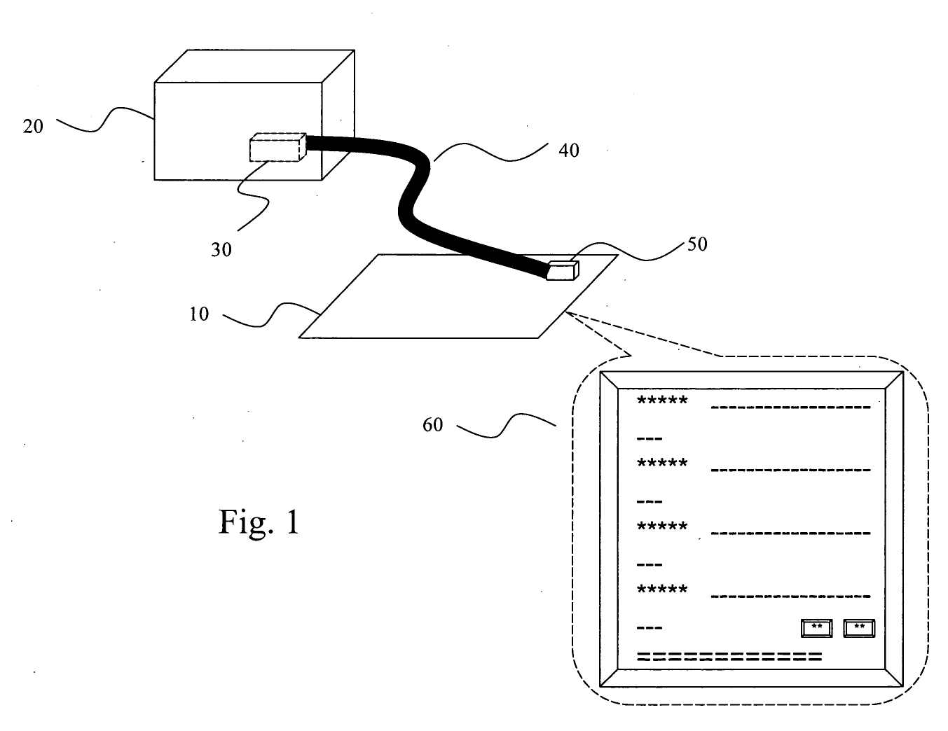

FIG. 1 is a schematic view of a power supply monitoring system through using a software instruction according to the present invention. The system includes: a computer motherboard 10; a power supply 20; a microprocessor 30, built in the power supply 20 and coupled to an electro-thermal adjusting unit (not shown) of the power supply 20, in which the electro-thermal adjusting unit is a fan monitoring device, a power supply control device, or a device combining the fan monitoring device with the power supply control device; a transmission line 40, for connecting the microprocessor 30 to a transmission interface 50 of the computer motherboard 10, in which the transmission interface 50 is USB, IEEE1394, or RS232 interface; and a power supply status monitor program 60, which is a software application for displaying operating status information of the power supply 20 and providing the software instruction to control the electro-thermal adjusting unit of the power supply 20. The operating status information is information about the electro-thermal adjusting unit, for example, the rotating speed of the fan monitoring device, a voltage control signal, or the information of the detected rotating speed of the fan, the voltage of the fan, and the temperature, or the status of the power supply control device.

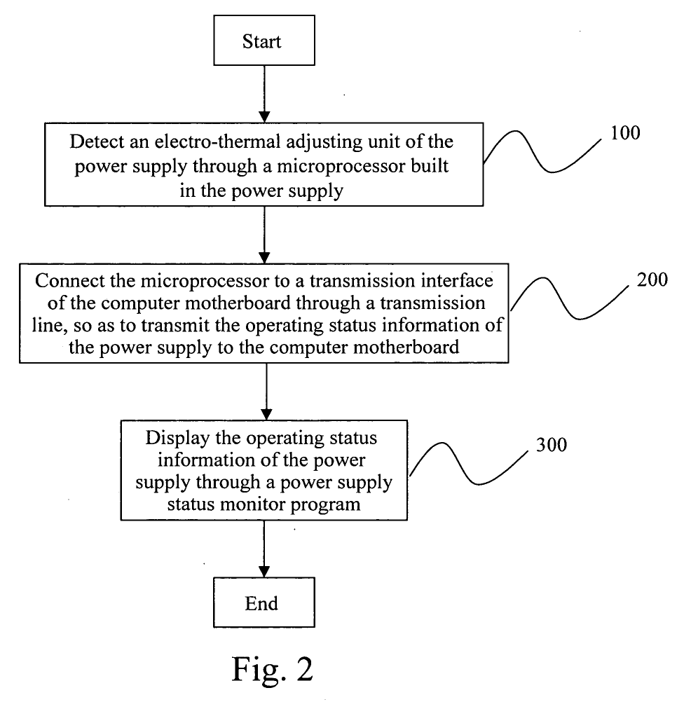

According to a first embodiment of the present invention, operating status information of the power supply is displayed through the software instruction. Referring to FIG. 2, an electro-thermal adjusting unit of the power supply is detected through a microprocessor built in the power supply (Step 100); then, the microprocessor is connected to a transmission interface of the computer motherboard through a transmission line, so as to transmit the operating status information of the power supply to the computer motherboard (Step 200); and finally, the operating status information of the power supply is displayed through a power supply status monitor program (Step 300).

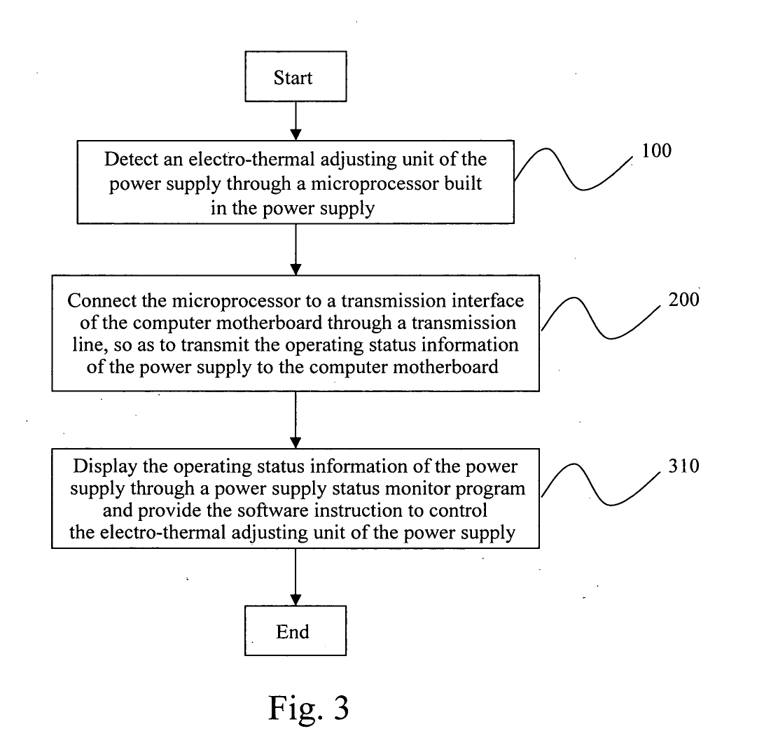

According to a second embodiment of the present invention, the operating status information of the power supply is controlled through a software instruction. As shown in FIG. 3, an electro-thermal adjusting unit of the power supply is detected through a microprocessor built in the power supply (Step 100); then, the microprocessor is connected to a transmission interface of the computer motherboard through a transmission line, so as to transmit the operating status information of the power supply to the computer motherboard (Step 200); and finally, the operating status information of the power supply is displayed through a power supply status monitor program and the software instruction is provided to control the electro-thermal adjusting unit of the power supply (Step 310).

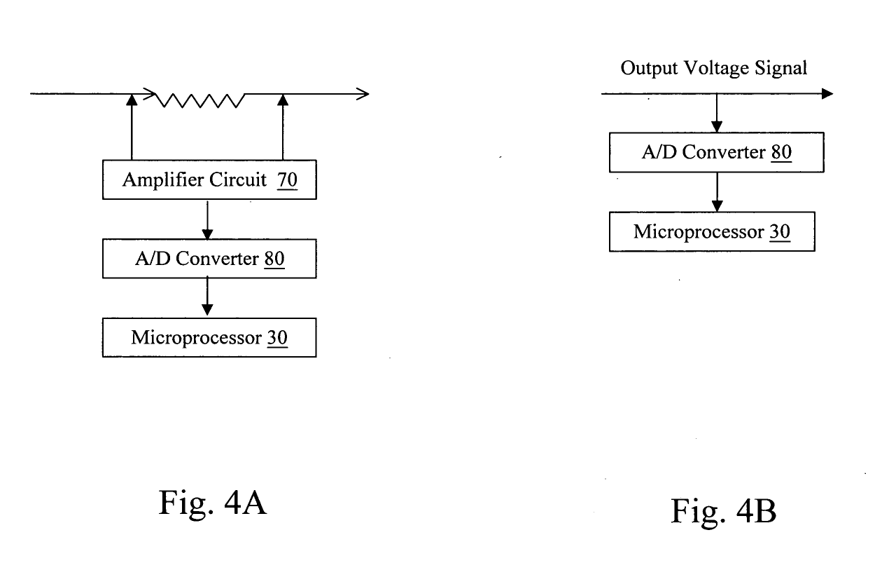

The operating status information of the power supply 20 is detected through the microprocessor 30. For example, in the present invention, referring to FIG. 4A, it is a schematic view of a circuit for detecting a current through a microprocessor 30. The obtained current is amplified through an amplifier circuit 70, and then, a detected signal is converted into a digital signal by an A/D converter 80 for being inputted into the microprocessor 30, so as to obtain the status information.

Referring to FIG. 4B, it is a schematic view of a circuit for detecting a voltage through a microprocessor 30. An output voltage signal is converted into a digital signal by the A/D converter 80, and then it is inputted into the microprocessor 30, so as to obtain the status information.

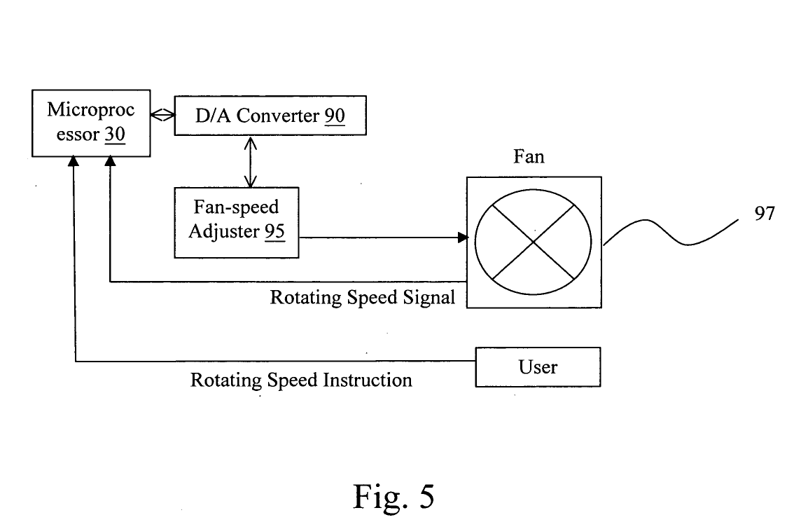

FIG. 5 is a schematic view of controlling the rotating speed of a fan for the power supply through a software instruction according to the present invention. Merely the rotating speed of the fan is taken as an example for illustration, but not to limit the application scope of the present invention. The present invention may be further used to display and control the output parameters (temperature, output voltage, and current) of the power supply 20. When the microprocessor 30 sends out and coverts a control signal through a D/A converter 90 and then inputs the signal into a fan-speed adjuster 95 to drive the fan 97 to rotate, the fan 97 feeds back a rotating speed signal to the microprocessor 30. Since the present invention controls the rotating speed of the fan for the power supply through the software instruction, the user may easily control the rotating speed of the fan 97 through the software application.

Since the power supply status monitor program 60 provided by the present invention is a software application designed according to a pin defined by the microprocessor 30, the power supply status monitor program 60 may be installed in an operating system according to the design of the power supply 20, so as to monitor the power supply through the software instruction. Furthermore, the power supply status monitor program 60 may be designed to serve as an automatic monitor for the system itself through manual control, or through the design of defined parameters, which does not limit the application scope of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A power supply monitoring system through using a software instruction, comprising:
a computer motherboard;
a power supply;
a microprocessor, built in the power supply and coupled to an electro-thermal adjusting unit of the power supply;
a transmission line, for connecting the microprocessor to a transmission interface of the computer motherboard; and
a power supply status monitor program, for displaying operating status information of the power supply and providing the software instruction to control the electro-thermal adjusting unit of the power supply.

2. The power supply monitoring system through using the software instruction as claimed in claim 1, wherein the transmission interface is USB, IEEE1394, or RS232.

3. The power supply monitoring system through using the software instruction as claimed in claim 1, wherein the electro-thermal adjusting unit comprises a fan monitoring device, a power supply control device, or a device combining the fan monitoring device with the power supply control device.

4. The power supply monitoring system through using the software instruction as claimed in claim 3, wherein the operating status information is a rotating speed or a voltage of the fan.

5. The power supply monitoring system through using the software instruction as claimed in claim 1, wherein the operating status information is a temperature detected by the electro-thermal adjusting unit.

6. The power supply monitoring system through using the software instruction as claimed in claim 1, wherein the power supply status monitor program is a software application.

7. A power supply for being monitored through a software instruction, comprising:
a microprocessor, coupled to an electro-thermal adjusting unit; and
a power supply status monitor program, for displaying operating status information of the power supply operating status information and providing the software instruction to control the electro-thermal adjusting unit of the power supply.

8. The power supply for being monitored through the software instruction as claimed in claim 7, wherein the microprocessor is built in the power supply, and connected to a transmission interface of a computer motherboard through a transmission line.

9. The power supply for being monitored through the software instruction as claimed in claim 8, wherein the transmission interface is USB, IEEE1394, or RS232.

10. The power supply for being monitored through the software instruction as claimed in claim 7, wherein the operating status information is a status or information detected by the electro-thermal adjusting unit.

11. The power supply for being monitored through the software instruction as claimed in claim 7, wherein the power supply status monitor program is a software application.

12. The power supply for being monitored through the software instruction as claimed in claim 7, wherein the electro-thermal adjusting unit comprises a fan monitoring device, a power supply control device, or a device combining the fan monitoring device with the power supply control device.
